(19) United States
(12) Patent Application Publication
(10) Pub. No.: US 2015/0242570 A1
(43) Pub. Date: Aug. 27, 2015

(54) ELECTRONIC HEALTH RECORD SYSTEM WITH CUSTOMIZABLE COMPLIANCE POLICIES

(71) Applicant: HEWLETT-PACKARD DEVELOPMENT COMPANY, LP, Houston, TX (US)

(72) Inventors: Jun Li, Palo Alto, CA (US); Jovan Stevovic, Palo Alto, CA (US); Ram Swaminathan, Palo Alto, CA (US); Hamid Reza Motahari-Nezhad, Palo Alto, CA (US)

(21) Appl. No.: 14/432,290

(22) PCT Filed: Sep. 9, 2012
(86) PCT No.: PCT/US2012/058194

§ 371 Date: Mar. 30, 2015

(51) Int. Cl. G06F 19/00; G06Q 30/00

(52) U.S. Cl. CPC G06F 19/322; G06Q 30/018

(57) ABSTRACT

A method performed by an electronic healthcare record (EHR) system with customizable compliance policies includes invoking a first data management process for a first data management operation, the first data management process defining a first set of compliance policies of a first healthcare participant for the first data management operation, and invoking a second data management process for the first data management operation, the second data management process defining a second set of compliance policies of a second healthcare participant for the first data management operation that differs from the first set of compliance policies.

### BACKGROUND

Electronic Health Records (EHRs) may enable healthcare participants (e.g., patients, healthcare providers, payers, and researchers) to improve coordination of care and access to health information. Although EHRs may facilitate access to healthcare information, the sharing of healthcare information may involve many complex technical and legal compliance issues. The compliance issues typically involve regulatory policies that can vary across states and countries. The sharing of healthcare information should also conform to the internal business requirements of healthcare participants. Even when adopting the same policies, each healthcare participant can interpret and implement policies and requirements differently in their internal information technology environments. These issues may be burdensome for healthcare participants that lack the resources and expertise to enable such sharing while ensuring consistency, privacy, and security of the healthcare information.

### BRIEF DESCRIPTION OF THE DRAWINGS

FIG. 1 is a block diagram illustrating one example of an electronic health record store and processing environment with customizable compliance policies.

FIG. 2 is a block diagram illustrating one example of a subset of data management interfaces.

FIG. 3 is a block diagram illustrating one example of a methodology for generating a data management process for a data management operation and identifying and generating security and privacy policies.

FIGS. 4A-4B are block diagrams illustrating examples of interactions with an electronic health record system.

FIGS. 5A-5B are block diagrams illustrating examples of data management processes for performing a data management operation.

FIG. 6 is a block diagram illustrating one example of a metadata tree and an encrypted data store.

FIG. 7 is a block diagram illustrating one example of a processing system for executing data management processes and policies.

FIG. 8 is a block diagram illustrating one example of a participant system for executing a business process.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As used herein, the term “healthcare participant” (also referred to as “participant”) refers to a patient, a healthcare provider, a payer, a researcher, or other suitable person involved in a healthcare process of a patient that generates and/or uses healthcare information corresponding to a patient. The term “patient” refers to a person that receives at least one healthcare service from a healthcare provider. The term “healthcare provider” (also referred to as “provider”) refers to a person and/or institution that provide(s) at least one healthcare service to a patient.

The term “electronic health record” (EHR) refers to a set of healthcare information generated by a healthcare participant and stored in an electronic format on at least one machine-readable storage medium. The term “encrypted electronic health record” refers to an electronic health record that has been encrypted with an encryption key such as a record key.

The term “metadata” refers to a set of information that describes at least one record, such as an electronic health record. The term “metadata tree” refers to a set of nodes that include metadata where each node has a specified relationship with at least one other node in the set.

As described herein, a compliance-aware data management solution for EHR systems is provided. The system allows healthcare participants to define their own security and regulatory compliance policies for accessing and sharing healthcare data in EHRs and enables enforcement of the requirements while sharing data with other participants. Data management operations are expressed as business processes and each business process operation is mapped into calls to low-level operations on data stores and policy enforcement points. The resulting processes, referred to herein as data management processes, enforce the policies that govern the access and sharing of data in EHRs between people and systems.

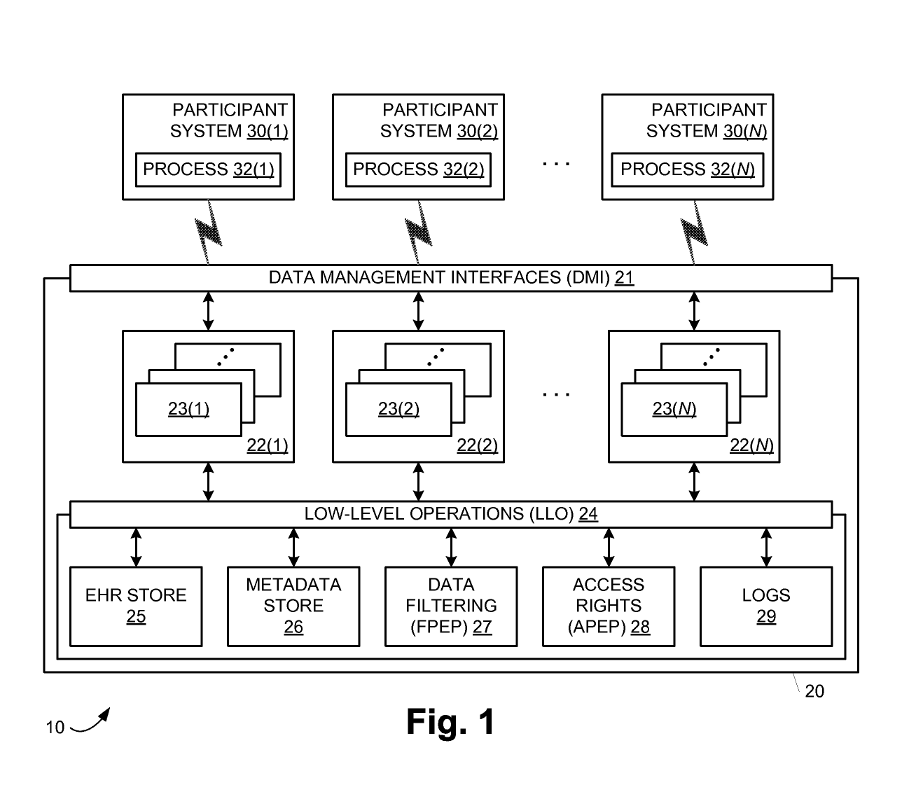

FIG. 1 is a block diagram illustrating one example of an electronic health record store and processing environment 10 with customizable compliance policies. Environment 10 includes an EHR system and a set of healthcare participant systems 30(1)-30(N) where N is an integer that is greater than or equal to two. Environment 10 provides the ability to share EHRs of patients with customizable compliance-aware policies using EHR store 20 and participant systems 30.

EHR system 20 includes data management interfaces (DMI) 21, a set 22 of data management processes 23 for each participant system 30, a set of low-level operations (LLO) 24, an EHR store 25, a metadata store 26, a data filtering unit 27, an access rights unit 28, and logs 29. DMIs 21 and LLOs 24 communicate with business processes 32 on participant systems 30 to manage accesses to EHR store 25 and metadata store 26 by participant systems 30.

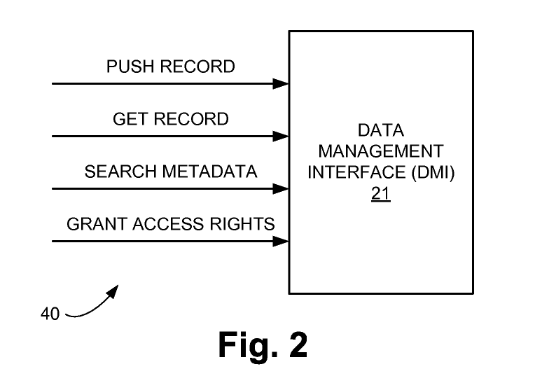

DMIs 21 represents granular data management operations (DMOs) 40 over data and rules such as Push Record, Get Record, Search Metadata, and Grant Access Rights as shown in the example of FIG. 2. The Push Record interface stores an EHR to EHR store 25 and creates a related metadata instance in metadata store 26. The Get Record interface allows participant systems 30 to request and access an EHR. The Get Record interface returns a requested EHR if the request is authorized, a denied status if the request is not authorized, or a wait status to indicate that approval is pending. The Search Metadata interface returns metadata from metadata store 26 that matches a search query for any metadata that a requesting participant system 30 is authorized to access. The Grant Access Rights interface grants or revokes categorical or individual access rights to EHRs and metadata, possibly for designated time periods. Any other suitable types of DMOs 40 may also be implemented in DMIs 21.

Each DMO 40 is implemented and customized by healthcare participants with data management processes 23 using modeling elements, data, operations, and rules. In one example, DMIs 21 use Business Process Model and Notation (BPMN) 2.0 elements as modeling elements for the definition of processes. Data management processes 23 perform operations on data and rules using LLOs 24 that are invoked by elements in data management processes 23 (e.g., BPMN Service Tasks elements). Operations may involve calls to EHR store 25, metadata store 26, data filtering unit 27, access rights unit 28, and logs 29. Operations may also involve calls to external systems, such as participant systems 30, to retrieve data, save logs or send messages according to the processes of a healthcare participant.

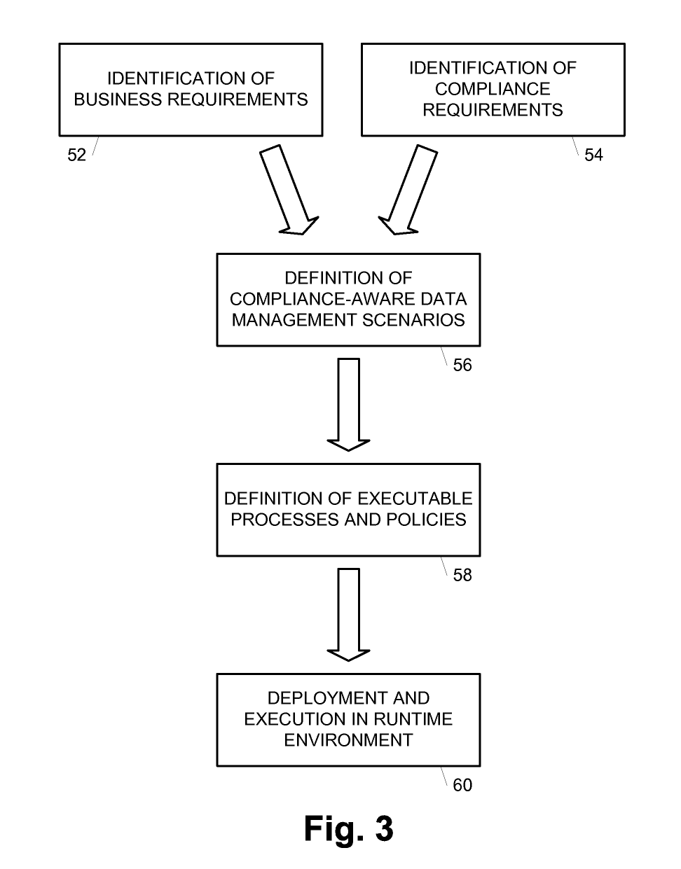

EHR system 20 forms a process repository to host the sets 22 of data management processes 23 implemented by healthcare participants. Healthcare participants typically include a data management process 23 for each DMO 40. To do so, a healthcare participant may customize an existing data management process 23 for a DMO 40 that has been defined by EHR system 20 or by other participants systems 30 or implement a custom data management process 23 for a DMO 40 using the methodology described with reference to FIG. 3 below.

LLO 24 defines a set of interfaces through which modeling elements in data management processes 23 perform operations on data (e.g., EHR store 25, metadata store 26, and logs 29) and rules (e.g., data filtering unit 27 and access rights unit 28). The operations of LLO 24 are mapped to the operations defined in EHR store 25, metadata store 26, data filtering unit 27, access rights unit 28, and logs 29 and include any suitable predefined input and output parameters.

The operations of LLO 24 are used also to access messaging channels with participant systems 30. Each participant system 30 may define its own topics and implement a custom event exchange protocol to satisfy the specific needs of the healthcare participant. The event-based topics may be used for auditing purposes or sending messages to appropriate auditors or governances, for example.

EHR store 25 stores encrypted EHRs of patients that were generated and provided by participant systems 30. The EHRs may be encrypted and decrypted by participant systems 30 using corresponding record keys. EHR store 25 includes any suitable type, number, and/or configuration of machine-readable storage media to store the EHRs. EHRs may be stored in a central location that is accessible to multiple participant systems 30. If EHR store 25 does not store the encryption keys (i.e., record keys) for the EHRs, EHR store 25 may not need to be a trusted data store (e.g., EHR store 25 may be owned or operated by one or more untrusted third parties).

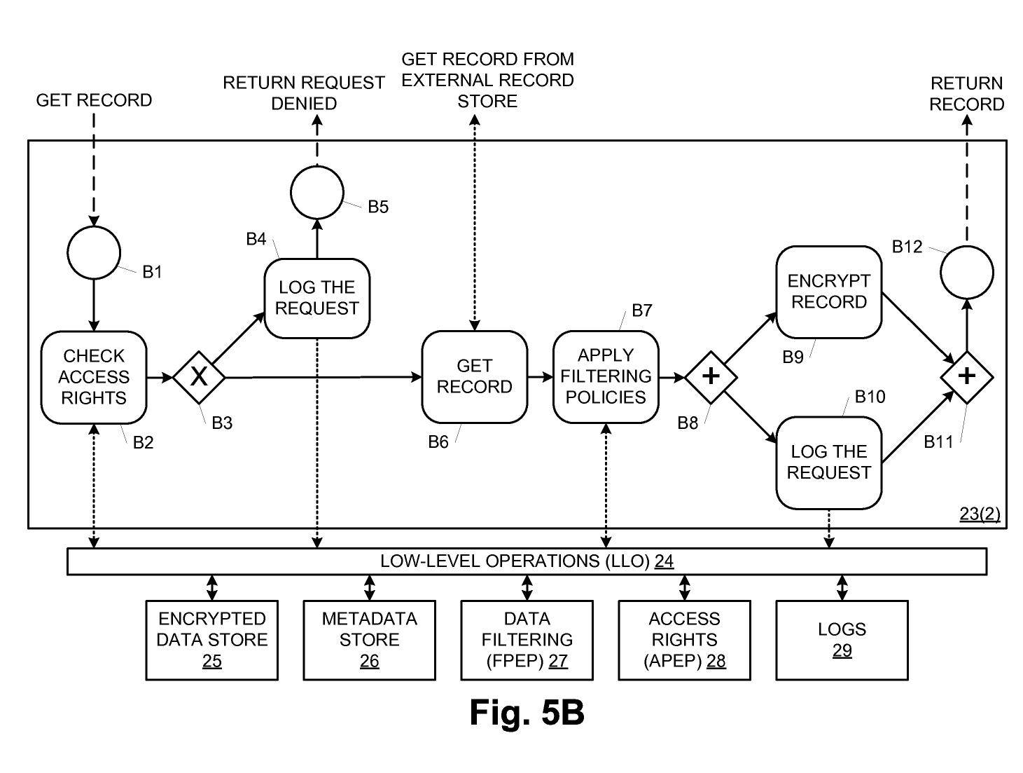

Metadata store 26 stores metadata for each patient and/or each patient record in EHR store 25. The metadata may be used to discover information about a patient and the EHRs of the patient and may be stored in a central location that is accessible to multiple participant systems 30. In one example, the metadata only includes the data necessary to identify a patient, a description of what occurred, the date and time of occurrence, and a source of the event. In another example shown in FIG. 6 and described below, metadata store 26 stores a metadata tree for each patient where each metadata tree with nodes arranged in a hierarchical tree structure where the leaf nodes include references to EHRs in EHR store 25.

Data filtering unit 27, also referred to as Filtering Policy Enforcement Point (FPEP) 27, performs operations using data filtering rules in response to calls from data management processes 23. Healthcare participants may use data filtering rules to specify the parts of EHRs that may be accessed by other healthcare participants as well as the purposes for which the EHRs may be accessed. For example, personally identifiable information may be masked when EHRs are used for business or research purposes.

Access rights unit 28, also referred to as Access Policy Enforcement Point (APEP) 28, provides access control to EHRs in EHR store 25 and metadata in metadata store 26 using access control rules in response to calls from data management processes 23. Access rights unit 28 allows rights to be granted to and revoked from healthcare participants based on rules provided by healthcare participants that manage the EHRs and metadata.

Logs 29 store any suitable log information for accesses to EHRs and metadata and uses of data management processes 23. Logs 29 may be used for auditing or other suitable purposes.

Participant systems 30 invoke corresponding data management processes 23 using any suitable business processes 32 of a healthcare participant that are executed on participant system 30.

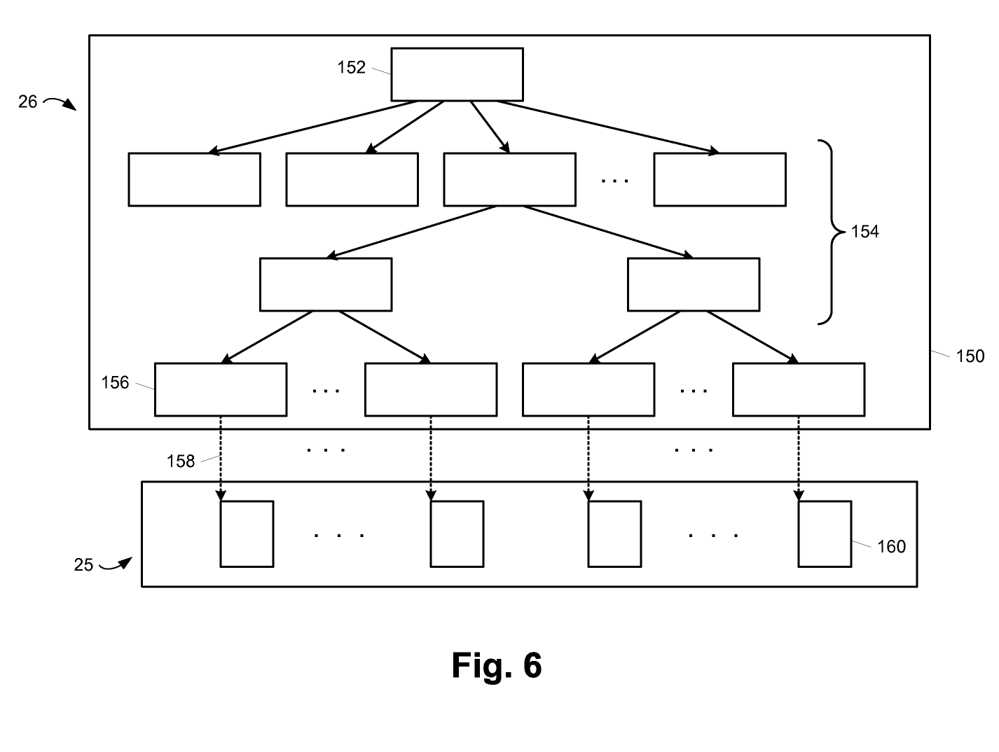

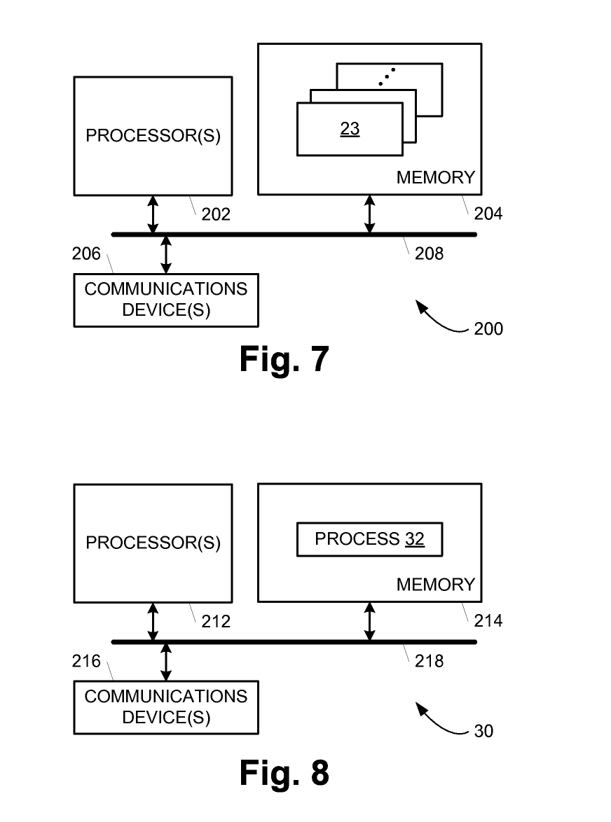

In environment 10, EHR system 20 and participant systems 30 may be implemented with any suitable type, number, and configuration of processing systems that each include one or more processors for executing instructions stored in one or more memories (i.e., computer-readable media). In particular, EHR store 25, metadata store 26, data filtering unit 27, access rights unit 28, and logs 29 may be implemented using different processing systems in some embodiments. An example of an EHR system 20 that executes data management processes 23 is shown in FIG. 7 and described in additional detail below. An example of participant system 30 is shown in FIG. 8 and described in additional detail below. In addition, any suitable type, number, and configuration of wired and/or wireless network devices (not shown) may be used to allow the processing systems to communicate.

FIG. 3 is a block diagram illustrating one example of a methodology for generating a data management process 23 for a data management operation 40 and identifying and generating security and privacy policies. The methodology of FIG. 3 may be used by each healthcare participant to define, translate, deploy and execute each data management process 23 for each data management operation 40.

As shown in a block 52, a chief information officer and/or other suitable persons working on behalf of a healthcare participant identifies the business requirements describing business specific requirements (e.g., the flow of interactions) and assigning flow steps to be fulfilled by different departments or healthcare participants. Such requirements may be described in a natural language with operational models describing how actors interact with EHR system 20.

As shown in a block 54, a chief compliance officer and/or other suitable persons working on behalf of a healthcare participant reviews the business requirements and follows compliance checklists to identify compliance requirements and security and privacy policies to incorporate. The chief compliance officer may define which security and privacy policies need to be applied at each step and identify exceptional cases in which data may be disclosed without patient authorization.

As shown in a block 56, a business analyst and/or other suitable persons working on behalf of a healthcare participant combines the business requirements and the compliance requirements to devise a high-level representation that describes the steps to be followed. The business analyst may also annotate the interaction diagram with the corresponding security and privacy policies identified in block 54.

As shown in a block 58, the business analyst, system developers, and/or other suitable persons working on behalf of a healthcare participant (e.g., administrators of EHR system 20 and the staff of a healthcare participant) translate the high-level representations into executable data management processes 23. Data management processes 23 implement the business logic of granular data management operations 40. Data management processes 23 reflect the identified compliance-aware data exchange interaction requirements and policies for corresponding healthcare participants. Security and privacy rules are also incorporated into data management processes 23 and enforced through operations using data filtering unit 27 and access rights unit 28. Data management processes 23 are deployed and executed into the shared execution environment of EHR system 20.

At execution time, data management processes 23 orchestrate multi-party human and system interactions that include healthcare participants and EHR system 20. Process steps in data management processes 23 define data accesses through a set of low-level operations 24 that are performed on EHR store 25 and metadata store 26. Process steps also perform low-level operations 24 to enforce the defined security and privacy rules at policy enforcement points in process 23.

Thus, the above methodology defines a sequence of steps carried out by multiple healthcare participants, in one example, from high-level business requirement collection to the low-level process execution and policy enforcement.

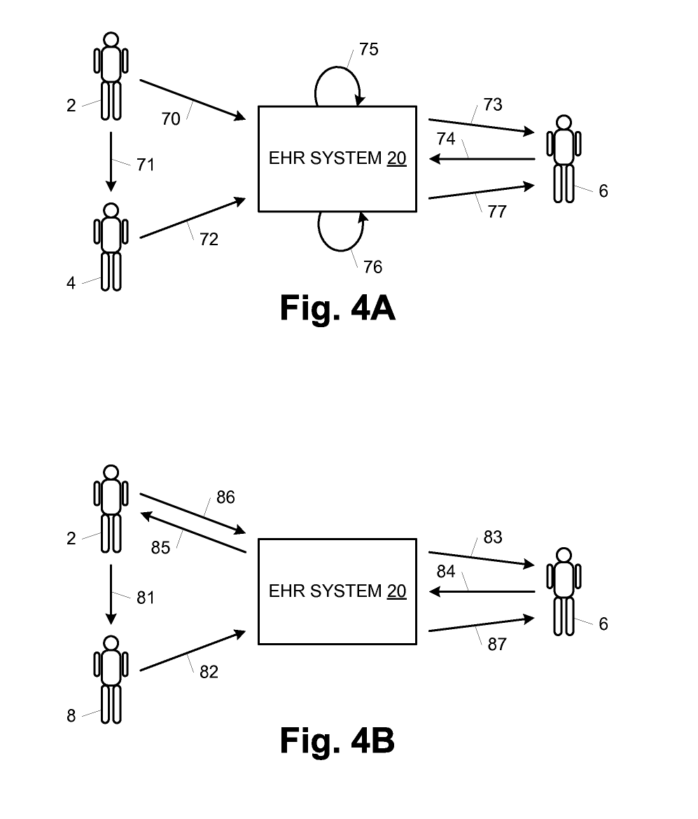

FIGS. 4A-4B are block diagrams illustrating examples of interactions with EHR system 20 with different sets of compliance policies for a Get Record DMO 40. The compliance policies may be from two different countries (e.g., The United Kingdom and Italy) and may differ based on privacy policies, security policies, and/or business specific requirements, for example.

In FIG. 4A, a patient 2 specifies sharing policies as indicated by an arrow 70 and provides a problem description to a healthcare provider 4 as indicated by an arrow 71. Healthcare provider 4 provides a consultation request to another healthcare provider 6 using EHR system 20 as indicated by an arrow 72, and EHR system 20 provides the consultation request to healthcare provider 6 as indicated by an arrow 73. Healthcare provider 6 requests EHRs of patient 2 from EHR system 20 as indicated by an arrow 74. EHR system 20 checks policies for the requested EHRs as indicated by an arrow 75 and retrieves the requested EHRs as indicated by an arrow 76. EHR system 20 provides the requested EHRs to healthcare provider 6 or the access denied response as indicated by an arrow 77.

In FIG. 4B, patient 2 provides a problem description to a healthcare provider 8 as indicated by an arrow 81. Healthcare provider 8 provides a consultation request to healthcare provider 6 using EHR system 20 as indicated by an arrow 82, and EHR system 20 provides the consultation request to healthcare provider 6 as indicated by an arrow 83. Healthcare provider 6 requests EHRs of patient 2 from EHR system 20 as indicated by an arrow 84. EHR system 20 requests approval from patient 2 to release the requested EHRs to healthcare provider 6 as indicated by an arrow 85 and receives approval or denial from patient 2 as indicated by an arrow 86. EHR system 20 provides the requested EHRs to healthcare provider 6 if approved and notifies healthcare provider 6 if denied as indicated by an arrow 87.

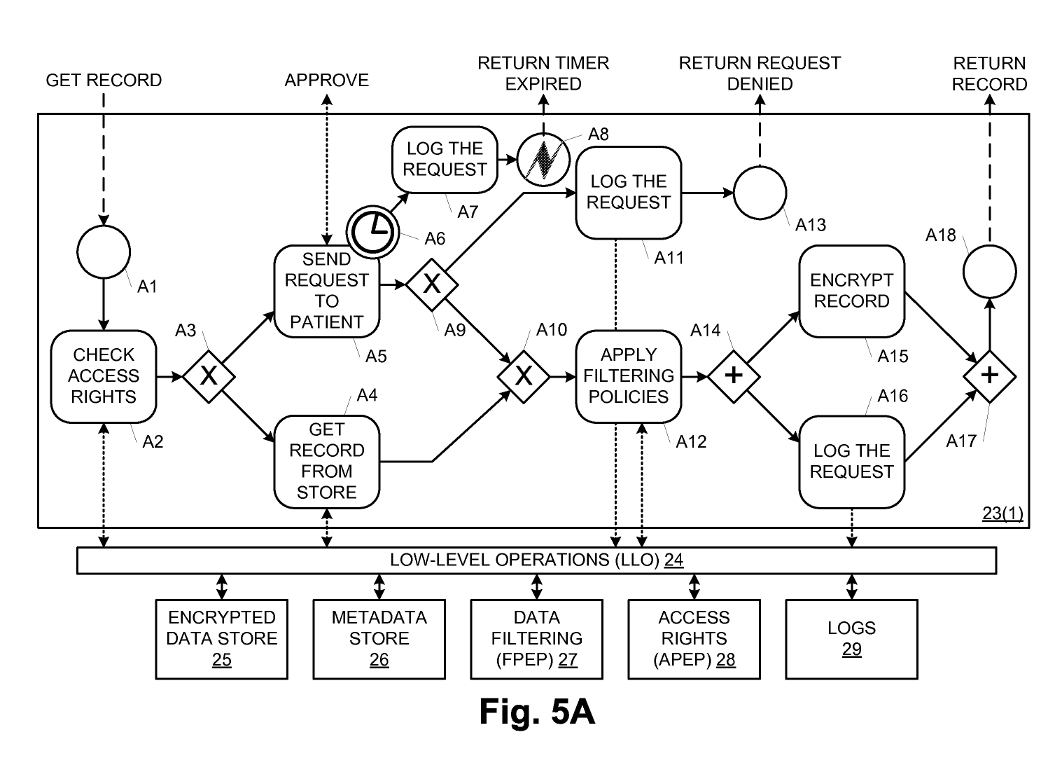

FIGS. 5A-5B are block diagrams illustrating examples of data management processes 23(1) and 23(2) for performing a Get Record DMO 40 with the different policies described by FIGS. 4A and 4B, respectively.

In FIG. 5A, a participant system 30 of healthcare provider 6 initiates a Get Record DMO 40 in step 74 by using a business process 32 to invoke a data management process 23(1) of healthcare provider 4. Data management process 23(1) starts with a start event element A1 to initiate service tasks A2, A4, and A5 which perform operations on data and rules. Task A2 checks the access rights for a requested EHR using access rights unit 28. The rule checking result of A2 is then used to take the appropriate decision within an exclusive gateway at A3. Service task A4 performs an operation on data by retrieving the requested EHR from EHR store 25. Service task A5 interacts with participant system 30 of provider 4 through operations on custom messaging channels. These custom channels allow exchanging messages with participant systems 30 and may be viewed as operations on remote data or rules. In particular, task A5 sends an authorization request for the requested EHR to a participant system 30 of patient 2. Patient 2 replies using participant system 30 to authorize or deny the request. A timer A6 defines the time interval within which the authorization request needs to be completed by patient 2. Gateways A9, A10, A14, and A17 perform merges, forks, and joins as indicated. Service tasks A8, A13 and A18 return the result for the Get Record DMO 40 with task A8 returning an error message, A13 returning a denied message if denied, and task A18 returning the requested EHR if authorized. Service task A12 applies purpose-based filtering policies from data filtering unit 27 after the requested EHR has been authorized. Service tasks A11 and A16 perform operations on data to write logs 29.

The Get Record data management process 23(2) in FIG. 5B illustrates differences in the use of modeling elements from data management process 23(1) in FIG. 5A while the overall set of operations on data and rules remains the same. In FIG. 5B, a participant system 30 of healthcare provider 6 initiates a Get Record DMO 40 in step 84 by using a business process 32 to invoke a data management process 23(2) of healthcare provider 6. Data management process 23(2) starts with a start event element B1 to initiate service task B2, B6, B7, and B9 which perform operations on data and rules. Task B2, like task A2, checks the access rights for a requested EHR using access rights unit 28. The rule checking result of B2 is then used to take the appropriate decision within an exclusive gateway at B3. Service task B6 performs an operation on data by retrieving the requested EHR from EHR store 25. Gateways B3, B8, and B11 perform merges, forks, and joins as indicated. Service tasks B5 and B12 return the result for the Get Record DMO 40 with task B5 returning a denied message if denied and task B12 returning the requested EHR if authorized. Service task B7 applies purpose-based filtering policies from data filtering unit 27. Service task B9 performs an operation on data by encrypting the requested EHR. Service tasks B4 and B10 perform operations on data to write logs 29.

FIG. 6 is a block diagram illustrating one example of metadata store 26 with a metadata tree 150 and EHR store 25. Metadata store 26 includes metadata tree 150 for each patient. As shown in FIG. 6, metadata tree 150 represents a hierarchical tree structure with a root node 152, any number of intermediate nodes 154, and a single leaf node 156 for each encrypted EHR 160 where each leaf node 156 stores metadata regarding a corresponding encrypted EHR 160. Root node 152 may include information that identifies the patient, intermediate nodes 154 represent logical groupings of EHRs 160 (e.g., by provider or by categories of patient information such as treatment conditions) and include information that describes the groupings, and leaf nodes 156 each include a single, unique reference 158 to a corresponding encrypted EHR 160 in encrypted data store 54 as well as information that describes the corresponding encrypted EHRs 160. References 158 may be used to access encrypted EHRs 160 in encrypted data store 54. In one embodiment, the entire metadata tree 150 is accessible by the patient and all providers that have registered with EHR system 20. In other embodiments, other security measures, such as encryption, may be applied to metadata tree 150 to limit access to metadata tree 150 to desired healthcare participants.

Metadata tree 150 may allow unaffiliated providers (e.g., providers practicing under different, unrelated business entities) to store different encrypted EHRs 160 of the patient to encrypted data store 54. Encrypted EHRs 160 may be encrypted with different record keys such that a record key for one encrypted EHR 160 may not be used to decrypt any other encrypted EHR 160. Providers may use metadata tree 150 to determine which encrypted EHRs 160 they need to access and can request access (i.e., record keys) from other providers that generated the needed encrypted EHRs 160 or the patient.

FIG. 7 is a block diagram illustrating one example of a processing system 200 for executing any or all of data management processes 23(1)-23(N) and corresponding policies from any or all of healthcare participant systems 30(1)-30(N) shown in FIG. 1. Processing system 200 includes a set of one or more processors 202 configured to execute a set of instructions stored in a memory system 204, memory system 204, and at least one communications device 206. Processors 202, memory system 204, and communications devices 206 communicate using a set of interconnections 208 that includes any suitable type, number, and/or configuration of controllers, buses, interfaces, and/or other wired or wireless connections.

Processing system 200 represents any suitable processing device or portion of a processing device such as a server computer, a laptop computer, a tablet computer, a desktop computer, a mobile telephone with processing capabilities (i.e., a smart phone), or another suitable type of electronic device with processing capabilities. Each processor 202 is configured to access and execute instructions stored in memory system 204 and to access and store data in memory system 204. Memory system 204 includes any suitable type, number, and configuration of volatile or non-volatile machine-readable storage media configured to store instructions and data. Examples of machine-readable storage media in memory system 204 include hard disk drives, random access memory (RAM), read only memory (ROM), flash memory drives and cards, and other suitable types of magnetic and/or optical disks. The machine-readable storage media are considered to be part of an article or article of manufacture. An article or article of manufacture refers to one or more manufactured components. Communications devices 206 include any suitable type, number, and/or configuration of communications devices configured to allow participant system 30 to communicate across one or more wired or wireless networks.

Each data management process 23 includes instructions that, when executed by processors 202, causes processors 202 to perform the functions of data management process 23 as described above.

FIG. 8 is a block diagram illustrating one example of a participant system 30 for executing a business process 32 of a healthcare participant that operates participant system 30. Any of participant system 30(1)-30(N) may be implemented using the embodiment shown in FIG. 8.

Participant system 30 includes a set of one or more processors 212 configured to execute a set of instructions stored in a memory system 214, memory system 214, and at least one communications device 216. Processors 212, memory system 214, and communications devices 216 communicate using a set of interconnections 218 that includes any suitable type, number, and/or configuration of controllers, buses, interfaces, and/or other wired or wireless connections.

Participant system 30 represents any suitable processing device or portion of a processing device such as a server computer, a laptop computer, a tablet computer, a desktop computer, a mobile telephone with processing capabilities (i.e., a smart phone), or another suitable type of electronic device with processing capabilities. Each processor 212 is configured to access and execute instructions stored in memory system 214 and to access and store data in memory system 214. Memory system 214 includes any suitable type, number, and configuration of volatile or non-volatile machine-readable storage media configured to store instructions and data. Examples of machine-readable storage media in memory system 214 include hard disk drives, random access memory (RAM), read only memory (ROM), flash memory drives and cards, and other suitable types of magnetic and/or optical disks. The machine-readable storage media are considered to be part of an article or article of manufacture. An article or article of manufacture refers to one or more manufactured components. Communications devices 216 include any suitable type, number, and/or configuration of communications devices configured to allow participant system 30 to communicate across one or more wired or wireless networks.

Each business process 32 includes instructions that, when executed by processors 212, causes processors 212 to perform the functions business process 32 as described above.

The above embodiments may advantageously allow healthcare participants to securely manage and share EHRs in a common EHR store. Healthcare participants control the ability of other healthcare participants to access and store selected EHRs of a patient using data management processes tailored for each participant. The data management processes may be configured to comply with applicable regulatory policies as well as internal business requirements such as security policies.

What is claimed is:

1. A method performed by an electronic healthcare record (EHR) system with customizable compliance policies, the method comprising:
executing a first data management process for a first data management operation, the first data management process defining a first set of compliance policies of a first healthcare participant for the first data management operation; and
executing a second data management process for the first data management operation, the second data management process defining a second set of compliance policies of a second healthcare participant for the first data management operation that differs from the first set of compliance policies.

2. The method of claim 1 wherein the first data management process accesses a first EHR from an EHR store, and wherein the second data management process accesses a second EHR from the EHR store.

3. The method of claim 1 wherein the first data management process accesses a first metadata from a metadata store, and wherein the second data management process accesses a second metadata from the metadata store.

4. The method of claim 1 wherein the first data management process calls a data filtering unit to perform an operation using a first data filtering rule, and wherein the second data management process calls the data filtering unit to perform an operation using a second data filtering rule.

5. The method of claim 1 wherein the first data management process calls an access rights unit to perform an operation using a first access control rule, and wherein the second data management process calls the access rights unit to perform an operation using a second access control rule.

6. The method of claim 1 further comprising:
invoking the first data management process responsive to a first business process of the first healthcare participant executed on a first participant system; and
invoking the second data management process responsive to a second business process from the first healthcare participant on a second participant system.

7. The method of claim 1 wherein the first data management operation performs at least one of storing an electronic healthcare record, accessing an electronic healthcare record, searching metadata of an electronic healthcare record, or granting access rights to an electronic healthcare record.

8. A processing system comprising:
a set of one or more processors; and
a memory storing a set of instructions that, when executed by the set of processors, cause the set of processors to:
execute a first data management process for a first data management operation, the first data management process defining a first set of compliance policies of a first healthcare participant for the first data management operation; and
execute a second data management process for the first data management operation, the second data management process defining a second set of compliance policies of a second healthcare participant for the first data management operation that differs from the first set of compliance policies.

9. The processing system of claim 8 wherein the first data management process accesses a first EHR from an EHR store, and wherein the second data management process accesses a second EHR from the EHR store.

10. The processing system of claim 8 wherein the first data management process accesses a first metadata from a metadata store, and wherein the second data management process accesses a second metadata from the metadata store.

11. The processing system of claim 8 wherein the first data management process calls a data filtering unit to perform an operation using a first data filtering rule, and wherein the second data management process calls the data filtering unit to perform an operation using a second data filtering rule.

12. The processing system of claim 8 wherein the first data management process calls an access rights unit to perform an operation using a first access control rule, and wherein the second data management process calls the data access rights to perform an operation using a second access control rule.

13. The processing system of claim 8 wherein the first data management operation performs at least one of storing an electronic healthcare record, accessing an electronic healthcare record, searching metadata of an electronic healthcare record, or granting access rights to an electronic healthcare record.

14. An article comprising at least one machine-readable storage medium storing instructions that, when executed by a processing system, cause the processing system to:
execute a first data management process for a first data management operation, the first data management process defining a first set of compliance policies of a first healthcare participant for the first data management operation; and
execute a second data management process for the first data management operation, the second data management process defining a second set of compliance policies of a second healthcare participant for the first data management operation that differs from the first set of compliance policies.

15. The article of claim 13, wherein the first data management operation performs at least one of storing an electronic healthcare record, accessing an electronic healthcare record, searching metadata of an electronic healthcare record, or granting access rights to an electronic healthcare record.
